(19) United States
(12) Patent Application Publication
(10) Pub. No.: US 2004/0218789 A1
(43) Pub. Date: Nov. 4, 2004

(54) Fingerprint reader using surface acoustic wave device

(76) Inventors: Andrew J. Polcha, Lovettsville, VA (US); Michael P. Polcha, Lovettsville, VA (US)

Correspondence Address: FLESHNER & KIM, LLP, P.O. BOX 221200, CHANTILLY, VA, 20153, US

(21) Appl. No.: 10/748,436

(22) Filed: Dec. 31, 2003

Related U.S. Application Data
(60) Provisional application No. 60/436,996, filed on Dec. 31, 2002.
(60) Provisional application No. 60/470,204, filed on May 14, 2003.

(51) Int. Cl. G06K 9/00

(52) U.S. Cl. 382/124

(57) ABSTRACT

An access control method achieves enhanced security and accuracy compared with other systems through recognition of one or more distorted biometrics. The method includes outputting a distorted biometric print from a surface acoustic wave (SAW) device into an identification system, comparing the distorted print to one or more distortion patterns, and controlling access to a restricted item based on results of the comparison. The distorted print maybe formed based on a transfer function or excitation frequency of the SAW device, or may be formed by a mask pattern located on or between a sensing surface of the SAW device. The print may be a fingerprint, thumb print, and palm print.

### REFERENCE TO RELATED APPLICATIONS

This application claims benefit of provisional U.S. Patent Application Ser. No. 60/436,996 filed on Dec. 31, 2002 and provisional U.S. Patent Application Ser. No. 60/470,204 filed on May 14, 2003. The contents of these provisional applications are incorporated by reference herein. This application also incorporates by reference the subject matter in pending U.S. patent application Ser. No. ______, filed on ______ entitled “Recoverable Biometric Identity System and Method” (Attorney Docket No. IQB-0015), pending U.S. patent application Ser. No. ______, filed on ______ entitled “System and Method for Performing Security Access Control Based on Modified Biometric Data” (Attorney Docket No. IQB-0021), and pending U.S. patent application Ser. No. ______ entitled “System and Method for Performing Personal Identification Based on Biometric Data Recovered Using Surface Acoustic Waves” (Attorney Docket No. IQB-0022).

### BACKGROUND OF THE INVENTION

1. Field of the Invention

This invention generally relates to sensing systems, and more particularly to a biometric sensor and a system and method for processing signals generate from the same.

2. Description of the Related Art

The ability to perform secure transactions, control access to restricted areas, and protect the dissemination of information are paramount concerns in the public and private sector. While various approaches have been developed to address these concerns, one approach which has proven to be particularly effective involves the use of biometrics.

Biometric systems use automated methods of verifying or recognizing the identity of persons based on some physiological characteristic (e.g., a fingerprint or face pattern) or aspect of behavior (e.g., handwriting or keystroke patterns). In its most basic form, this is accomplished in three steps. First, one or more physiological or behavioral traits are captured and stored in a database. Second, the biometric of a particular person to be identified is compared to the information in the database. Finally, a negative or positive confirmation is returned based on results of the comparison.

Because personal characteristics or behavioral aspects are considered unique, biometric systems have proven to provide an enhanced measure of protection compared with password- and PIN-based systems. This enhanced security comes in several forms. For example, the person to be identified is required to be physically present at the point-of-identification. Visual or physiological confirmation therefore takes place instead of a mere numerical comparison. Also, biometric identification is beneficial to the user because it obviates the need to remember a password or carry a token.

While existing biometric systems have proven effective, they are not without drawbacks. Perhaps most significantly, these systems can be breached using stolen biometric data. Consider, for example, a biometric system which performs identification based on employee fingerprints. In order to gain unauthorized access, a thief can obtain a sample of an employee's fingerprint (e.g., off of a glass) with relative ease and then present that sample to a system fingerprint reader. Unable to determine the source of the fingerprint, the system will grant access to the thief to thereby causing a breach. Existing biometric systems have also proven to be inaccurate because they are one-dimensional in nature, e.g., they perform identification verification based on only form of biometric data.

Due at least in part to the tragic events of 9/11, the use of biometrics systems is expected to increase dramatically in the coming years. In fact, according to the International Biometric Industry Association, the biometrics market has been projected to jump from $165 million in 2000 to $2.5 billion by 2010. This jump will inevitably involve using biometric systems in new applications including the prevention of unauthorized access or fraudulent use of ATMs, cellular phones, smart cards, desktop PCs, workstations, and computer networks.

In view of the foregoing considerations, it is apparent that there is a need for a biometric-based access control system and method which is more secure than other systems and methods which have been proposed, and more particularly which achieves this improved security based on the use of multiple degrees of uniqueness for achieving identification confirmation.

### SUMMARY OF THE INVENTION

An object of the present invention is to provide an improved system and method for performing access control based on biometric information.

Another object of the present invention is to provide an access control system and method which is more secure than existing systems and methods.

Another object of the present invention is to provide a system and method of the aforementioned type which demonstrates a greater resilience to tampering and fraudulent attack from unauthorized personnel.

Another object of the present invention is to provide an access control system and method which performs more accurate identification than other systems which have been proposed.

Another object of the present invention is to provide an access control system and method which identifies enrolled users more accurately by considering multiple degrees of uniqueness, based solely on biometric data or on a combination of biometric data and one or more unique attributes.

Another object of the present invention is to provide an access control system and method which is sufficiently flexible to perform personal identification confirmation based on a fingerprint, thumbprint, or palm print.

Another object of the present invention is to provide a computer-readable medium containing an application program which performs access control in any of the aforementioned ways.

These and other objects and advantages of the present invention are achieved by providing an access control method which includes receiving a signal indicative of a combination of two or more unique identity attributes, at least one of the unique identity attributes corresponding to a fingerprint, thumbprint, or palm print of a person, comparing the signal to one or more identity patterns, and controlling access to a restricted item based on results of the comparing step. The signal indicative of the combined identity attributes is output from a surface acoustic wave (SAW) device, which includes a sensing surface for detecting the print either in an unmodified form or after the print has been distorted or otherwise modified by the second identity attribute. The restricted item may be an area or system subject to restricted access.

In accordance with one embodiment, the second unique attribute is a predetermined transfer function built into the SAW device, for example, through a structural arrangement of its interdigital transducers. The transfer function is uniquely selected to distort or otherwise modify the fingerprint signal output from the SAW device in a unique way which maybe recognized for performing identification and access control.

In accordance with another embodiment, the second unique attribute is a predetermined frequency of an oscillating voltage signal applied to the input transducer of the SAW device. This frequency uniquely influences the fingerprint signal output from the SAW device in a way which allows identification and access control to be performed.

In accordance with another embodiment, the second unique attribute is a mask pattern which, for example, maybe included on a film overlying the sensing surface of the SAW device. The deformation of the piezoelectric substrate that occurs from the fingerprint ridges and mask pattern generates a distorted print signal which allows identification and access control to be performed.

In accordance with another embodiment, the second unique attribute is a pattern which is removably coupled to or permanently formed in the piezoelectric layer of the SAW device. The deformation of the piezoelectric substrate that occurs from the fingerprint ridges and the piezoelectric pattern generates a distorted print signal which allows identification and access control to be performed.

By distorting the print pattern input into the system, the present invention ensures that system security cannot be breached by theft of the biometric itself. The distortion therefore in effect serves as a key which when combined with the print provides two degrees of uniqueness which must be satisfied before a positive identification result can be confirmed. Moreover, if the distorted print of a person is ever lost or stolen, the present invention can easily re-enroll different distorted prints into the system or switch to a different previously enrolled print altered using a different form of distortion. Under these circumstances, the SAW device maybe removably mounted at an access point of the system, so that the device may be replaced with a SAW device having a different transfer function, mask pattern, or another second identity attribute. Additional embodiments contemplate combining three or more degrees of uniqueness for providing an even greater level of security.

### BRIEF DESCRIPTION OF THE DRAWINGS

FIG. 1 is a diagram showing a biometric identification system in accordance with one embodiment of the present invention.

FIGS. 2(a) and 2(b) are diagrams showing one type of control panel used in accordance with the present invention, where FIG. 2(a) shows the display of a first message on a control panel screen and FIG. 2(b) shows the display of a second message on the control panel screen.

FIG. 3 is a diagram showing steps included in a biometric identification method in accordance with one embodiment of the present invention.

FIG. 4 is a diagram showing a surface acoustic wave device for outputting a distorted biometric print in accordance with one embodiment of the present invention.

FIGS. 5(a) and 5(b) are diagram showing propagation and displacement directions of a surface acoustic wave that may be formed in the device of FIG. 4.

FIG. 6 is a diagram showing a surface acoustic wave device for outputting a distorted biometric print in accordance with another embodiment of the present invention.

FIG. 7 is a diagram showing how a sensing surface of the surface acoustic wave device may perceive a fingerprint through a mask included in the device of FIG. 6.

FIG. 8 is a graph showing an example of a spectral signal corresponding to a distorted biometric print output from the device of FIG. 6.

FIG. 9 is a diagram showing an access control system in accordance with another embodiment of the present invention.

FIG. 10 is a diagram showing an access control system in accordance with another embodiment of the present invention.

### DESCRIPTION OF THE PREFERRED EMBODIMENTS

The present invention is a system and method for controlling access to one or more restricted areas, systems, or other secured items of interest based on the identification of biometric data which has been altered, modulated, encoded, or otherwise distorted prior to input into the system. The restricted areas include buildings, rooms, or any other location where access is to be controlled, e.g., private residences, companies, public/private facilities including plants, military bases, laboratories, police crime labs, etc. Restricted systems include computers (e.g., main frames, desktops, portables including PDAs and notebooks), computer networks (e.g., Internet-based systems, ones performing e-commerce transactions and on-line banking), financial systems (e.g., ATMs, ones performing credit-card-based transactions), communication systems used in the public and private sector, as well as other system for which restricted access is sought or deemed to be desirable.

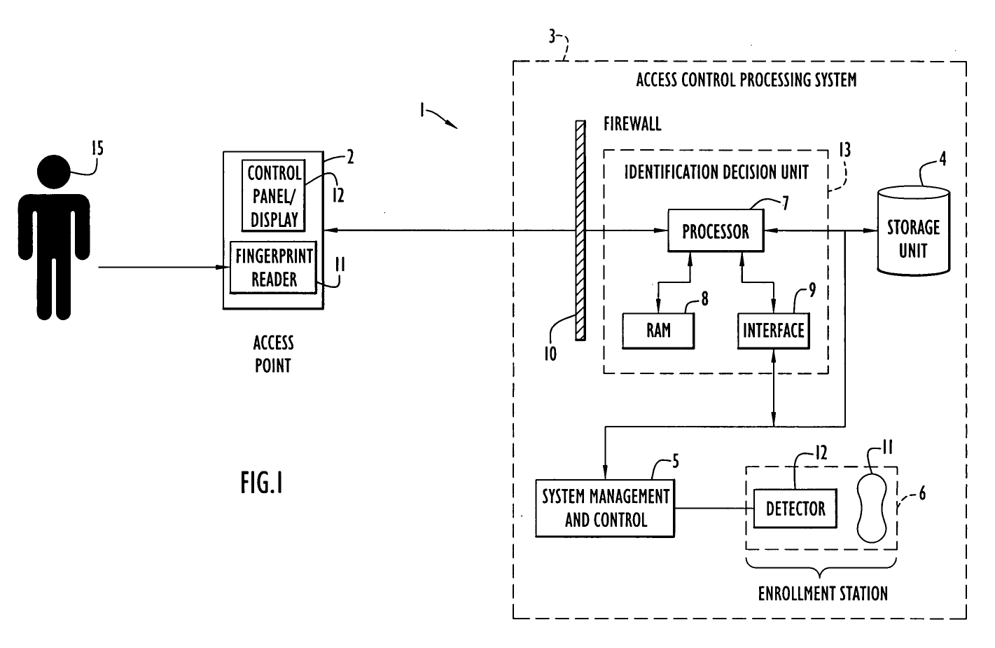

FIG. 1 shows an access control system 1 according to one embodiment of the present invention. This system includes an access point 2 and an access control processing system 3 which may be provided at separate locations and linked together by any number of wireline or wireless connections, or the elements may be combined to form a single integrated unit sized to fit a particular application.

The access point includes a sensor 11 which detects a person's fingerprint, thumbprint, or palm print which is distorted or otherwise altered in accordance with the present invention. The distortion is performed for the purpose of altering the print from its original form, thereby ensuring that inputting a person's fingerprint directly into the system will always result in failed recognition. This provides an enhanced measure of protection against biometric theft and unauthorized system access. In terms of physical dimensions, the sensor may be as small or large as necessary to be compatible with the host system.

To make security access more convenient and informative, the access point may also include a control panel 12 with a display or other indicator that provides information, instructions, and/or messages to each person presenting a print for identification. A keyboard or other data input device may also be included for receiving information including, for example, additional identification data in the form of a PIN or password. Additional biometric sensors may optionally be included to provide redundancy that maybe relied on as a basis for confirming or denying an identification result returned by the system.

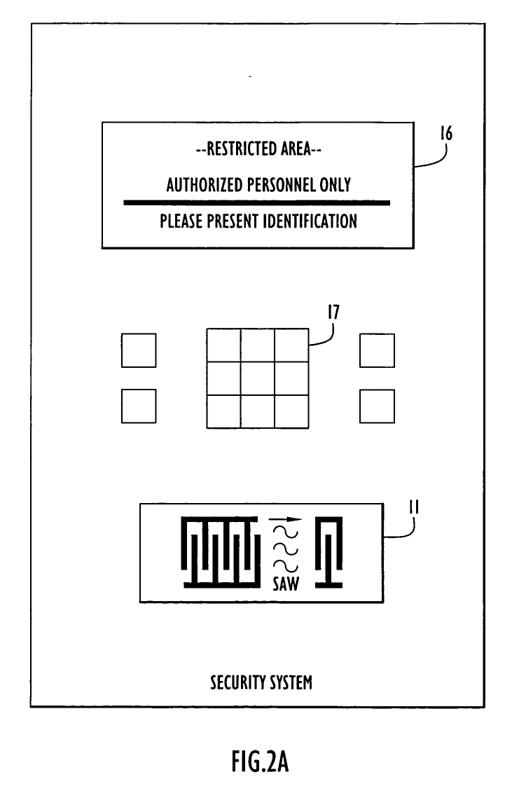

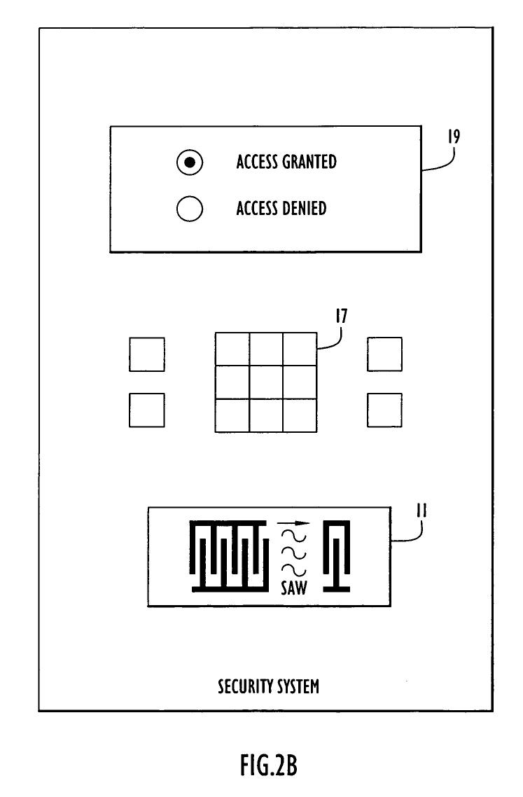

FIG. 2(a) shows one type of control panel that maybe included at the access point. This control panel includes a display screen 16, a keypad and/or a number of function buttons 17, and sensor 11 for detecting or receiving a distorted print. In an initial state, the display screen may display a warning that an area or system associated with the display panel is subject to restricted access. The screen may also include an instruction to enter identification information into the system. This may include presenting a distorted biometric for detection by the detector either alone or in combination with one or more other unique identity attributes. FIG. 2(b) shows a screen 19 which maybe generated to indicate that access has been granted by the control system based on the entered identification information.

Returning to FIG. 1, the access control processing system 3 includes an identification decision unit, a storage unit 4, a system management controller 5, and an enrollment station 6. The storage unit stores information for each person to be identified by the system. This information includes an identity pattern that corresponds to a distorted print obtained during an enrollment process and optionally but desirably one or more other forms of identifying data (e.g., PIN or other access number or password, social security number, driver's license number, address, citizenship, marital status, and/or other forms of personal information that may be used as an independent basis for identification).

The storage unit may store multiple identity patterns for each person, where each pattern is generated using a different form of distortion. This provides a degree of flexibility to the system while simultaneously enhancing security. For example, a system manager or system software may change the form of distortion to be used and thus the identity patterns to be searched on a periodic basis or when a breach of the host system has occurred.

Structurally, the storage unit may be a database included within or externally connected to the identification decision unit via a wireless or wireline communications link. Alternatively, the storage unit may be a memory chip storing the identity patterns for each person presented for identification. This latter case is preferable when, for example, the system is formed as an integrated unit. Those skilled in the art can appreciate that other forms of storage devices maybe used to store the identity patterns in accordance with the present invention.

The identification decision unit 13 compares the distorted print received from the sensor with one or more identity patterns in the storage unit. The comparison function is performed by a processor 7 under control of an application program stored in a memory 8. The type of comparison performed depends on the type of distortion imposed on the print. For example, the comparison may involve a spectrum signal analysis or a pattern recognition analysis performed using a neural network, statistical model, or other type of signal processing technique. As an added measure of security, the identification decision unit may be protected by a firewall and an interface unit 9 may be included for transmitting or receiving data, instructions, or other information from the system management controller.

The enrollment station captures new distorted prints for persons who are already registered in the system and for persons to be added. To perform this function, the enrollment station includes a sensor 14 for detecting or otherwise generating the distorted prints. In order for positive identification to occur, a print must be input into the system (e.g., at the access point) which has the same type of distortion that was imposed during enrollment, e.g., sensors 11 and 14 must detect or otherwise generate for input into the system substantially the same type of distorted print for each person authorized for access. The identification system of the present invention thus maybe said to require at least two unique identity attributes to be presented in proper combination in order for a positive identification to occur, where the first and second unique attributes respectively correspond to the print and the specific type of distortion imposed on the print. While the enrollment station is depicted to be separate from the access point, those skilled in the art can appreciate that enrollment may also be performed by the sensor at the access point.

The system management controller generates new identity patterns from the distorted prints obtained from the enrollment station. These patterns are then forwarded to the storage unit. The controller also performs a number of other management functions. For example, when multiple identity patterns (e.g., multiple distorted prints, or prints and one or more other distorted or undistorted biometrics) are stored for each person, the controller may specify which distorted biometric type is to be used by the decision unit for identification.

To illustrate, consider the case where each person has enrolled two distorted fingerprints into the system. The enrolled prints may differ based on the use of different types of distortion for the same fingerprint or use of the same type of distortion for different fingerprints. The system management controller may control which type of distorted print may be used on any given day or under any given set of circumstances for identification. For example, a thumb print scanned through a first nonlinear distortion element may be system active one day and the same thumb print scanned through a second nonlinear distortion element maybe system active on another day. A positive identification will only result by inputting the correct distorted print into the system. The system controller manages which distorted biometric will be active based on direct input from a system administrator or based on instructions which have been programmed into the processor control software, e.g., on a periodic basis, in the event that a host system breach has occurred, etc.

In addition to these functions, the system controller maybe used to edit and/or delete identity patterns or other identification information in the storage unit. Also, this controller may control the access point control panel and sensor in terms of when they are active and what messages, information, or other data is to be displayed. If multiple biometric sensors are included at the access point, the controller may also designate which sensor or combination of sensors is to be activated.

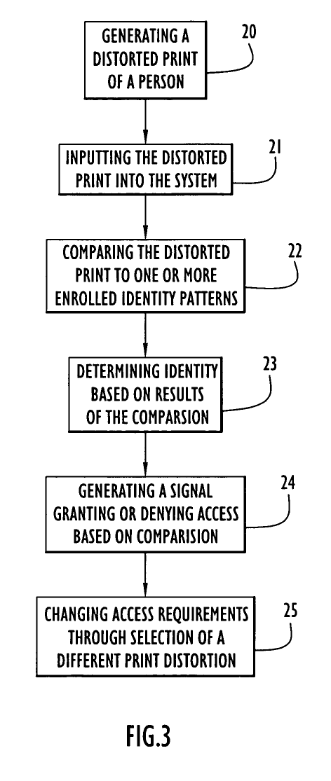

FIG. 3 shows steps included in one embodiment of an identification method of the present invention, which maybe performed using the system shown in FIG. 1. An initial step of this method includes generating a distorted print of a person. (Block 20). The distorted print is generated using a type of distortion which is selected to be compatible with the print. This distortion maybe imposed by a distortion element located between the sensor and the part of the person's body containing the print or the distortion may be internally generated within the sensor, or both.

A second step includes inputting the distorted print into the identification system. (Block 21). This maybe accomplished in a variety of ways depending on the type of distortion imposed. For example, if the distortion is imposed by a distortion element located between the print and sensor, the distorted print is generated as a result of the ridges of the print being detected through the distortion element. If the distortion is internally generated, the sensor may detect the print as a spectrum signal modified using a predetermined transfer function. Other examples of how a distorted print may be captured, detected, generated, or otherwise input into the system are discussed in the specific embodiments which follow.

A third step includes comparing the distorted print signal received from the sensor to one or more identity patterns stored in the storage unit. (Block 22). This step is performed by decision unit 3, which searches the distorted prints in the stored identity patterns previously enrolled. As previously indicated, the comparison performed depends on the specific type of distorted print received. This may involve, for example, various forms of spectrum or pattern analyses. Specific embodiments are discussed below.

A fourth step includes determining an identity of the person who input the distorted print into the system. (Block 23). The identity is determined based on results obtained from the comparison performed by the decision unit. If the distorted print signal matches one of the identity patterns, then the identity of the person may be determined from the personal information stored in that person's electronic file. Under ideal circumstances, the processor search would result in only one match for each authorized person. However, because of inconsistencies and other adverse influences, it is possible that multiple matches are found. In this case, the processor may be programmed to conclude that there is no match because of an ambiguity. Conversely, the processor may programmed to conclude that for purposes of the host system, any match is sufficient and therefore multiple matches result in an acknowledgment that the person is a person recognized by the system. If no match is produced from the processor search, the system may conclude that the person is an unidentified person and action may be taken accordingly.

A fifth step includes generating a signal indicating whether access has been granted or denied. (Block 24). An access granted signal is generated when the person who input the distorted print into the system has been identified. When this occurs, the signal may control one or more features of the host system to give the person access. For example, the access control signal may open a lock on a door leading to a restricted area, adjust parameters that will allow access to a computer system, enable a financial transaction to take place, or any other function controlled by or otherwise associated with the host system under care and protection of the present invention. The access granted signal may be accompanied by display of a message on the control panel indicating that access has been given.

An access denied signal is generated when the person who input the distorted biometric has not been identified. When this occurs, a corresponding message may be displayed at the control panel. Also, one or more additional features of the control panel maybe activated for protection purposes. For example, an image of the person maybe taken and stored in memory by a camera in or proximate the control panel. If fraudulent entry or tampering is suspected, the image may be given to the authorities for purposes of locating and taking the individual into custody. A number of specific embodiments of the access control system of the present invention will now be discussed.

A sixth step includes changing the access requirements of the system, for example, on a periodic basis and/or in the event the system was breached through fraud or tampering. (Block 25). Since the distortion element may be considered in conceptual terms to be a “key” for gaining access in the control system, changing access requirements may include changing “keys.” This may be accomplished in one of several ways. For example, each person authorized for access to the host system may be required to input two or more distorted prints during the enrollment process. Changing system requirements may involve switching from one distorted print (e.g., forefinger print detected using one transfer function) to another (e.g., the same forefinger print detected using another transfer function) in the identification decision unit. Alternatively, the decision unit maybe programmed to require input of additional identification information (e.g,. a PIN or password) along with the same distorted print. Changing system access requirements in this manner allows the present invention to provide an added measure of protection unrecognized by other biometric-based access systems which have been proposed.

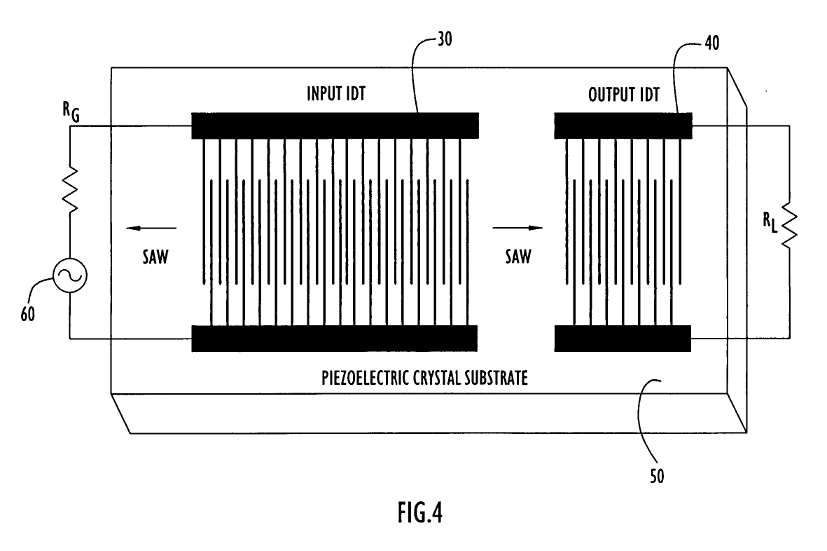

FIG. 4 shows a first embodiment of a fingerprint sensor that maybe used to input a distorted print signal into the processing system for identification. This sensor includes a surface acoustic wave (SAW) device having two arrays of interdigital electrodes 30 and 40 formed on a layer 50 of piezoelectric material. Electrode array 30 forms an input transducer which is electrically coupled to an excitation source 60 (e.g., a voltage signal generator) through a resistor R_{G}, and electrode array 40 forms an output transducer which is electrically coupled to a load resistor R_{L}. The transducers are spaced by a predetermined amount to effectively form a delay line. The spacing maybe proportional to a fraction or multiple of the wavelength of the surface wave. Layer 50 may be a substrate or thin film made from any one of a variety of PZT materials such as, for example, PbTiO₃. The interdigital electrodes maybe exposed or protected by an overlying film which serves as a detecting surface of the sensor. Acoustic absorbers maybe formed on the ends of the substrate to dampen surface waves and prevent reflections.

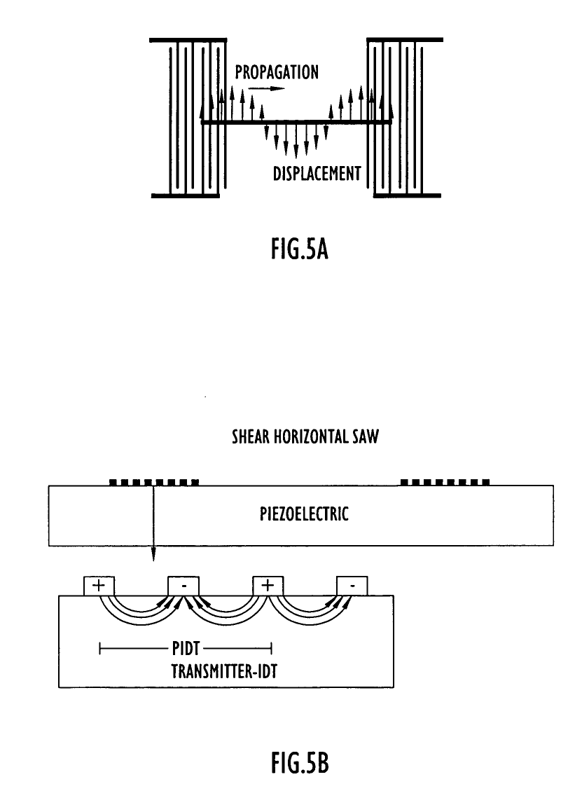

In accordance with the first embodiment, the sensor generates a distorted fingerprint using a predetermined transfer function. The transfer function maybe based on the characteristics of the interdigital electrodes or maybe formed by other known techniques. In operation, when the excitation source applies an oscillating voltage signal to the input transducer, mechanical forces are generated. These forces form surface acoustic waves which propagate along the substrate until they are detected by the output transducer. During this process, surface wave displacements occur in a direction perpendicular to the direction of propagation of the wave (FIG. 5(a)), as well as in the plane of and/or perpendicular to the surface of the piezoelectric substrate. The wave displacements also take place between the so-called “fingers” of the interdigital transducers (FIG. 5(b)), as well as between the transducers themselves. As a result of the piezoelectric effect, substrate deformations (expansions and contractions) produced by the displacements generate electrical signals having spectral characteristics which are determined by the transfer function of the sensor.

During biometric data entry a person places his finger over a detecting surface of the sensor, which at least partially includes the input and output transducers or an area therebetween. The ridges in the fingerprint cause the piezoelectric substrate to further deform. The combined deformation that occurs from the surface wave displacement and the fingerprint ridges produces an electrical signal having a unique spectral signature which is influenced by the sensor transfer function. The spectral characteristics of the signal are analyzed by the identification decision unit (e.g., by performing a peak-to-peak analysis) and compared to stored patterns to return an identification result.

The transfer function of the SAW device thus maybe said to impose a specific distortion on a fingerprint. Put differently, the SAW device outputs a signal that includes two degrees of uniqueness, one based on the fingerprint and another based on the specific transfer function of the sensor. By combining these attributes, a biometric signal pattern maybe formed which maybe used as a basis for security access control.

Should a system breach or theft occur, the present invention is sufficiently flexible to overcome this situation. For example, the fingerprint sensor maybe constructed to be removably mounted at the access point. If a breach occurs, the sensor may be replaced with another sensor having a new transfer function. If identity patterns based on the new transfer function have already been stored in the system, access control maybe performed virtually without interruption. Otherwise, a new enrollment procedure maybe performed. If desired, the access point may be replaced on a periodic basis to provide an additional safeguard against system breaches.

Another embodiment of the fingerprint sensor is also based on a SAW device, except in this embodiment the fingerprint is modified based on the frequency of the oscillating voltage applied to the input transducer. The specific frequency selected for the oscillating signal directly influences the surface waves formed in the sensor and consequently the form of the signal output from the sensor. The combined deformation that results from these waves and the ridges in a user's fingerprint generates a unique biometric which can be compared by the identification decision unit to return an identification result. The frequency of the oscillating voltage may be selected within a predetermined range, which, for example, may be measured on its low end in kilohertz and on its high end in by gigahertz. Other ranges may be selected if desired.

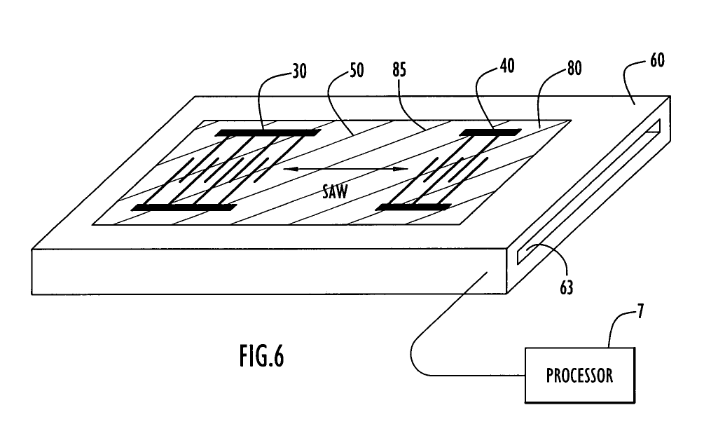

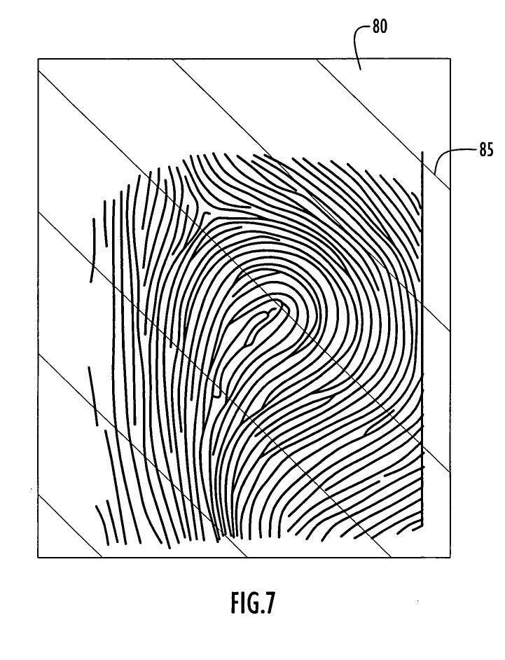

Another embodiment of the fingerprint sensor is also based on a SAW device, except in this embodiment the fingerprint is modified by a mask or thin film 80 placed over the sensor. This mask may include a predetermined pattern 85 of bumps, ridges, or other deformations that project downwardly into the piezoelectric substrate. This pattern of deformations produces a recognizable spectral pattern which when combined with fingerprint ridges produces a unique spectral signature that can be used for identification and access control. FIG. 6 shows an example of mask which includes a cross-hatch pattern, and FIG. 7 shows a view from the back side of the mask with a fingerprint contacting the front side.

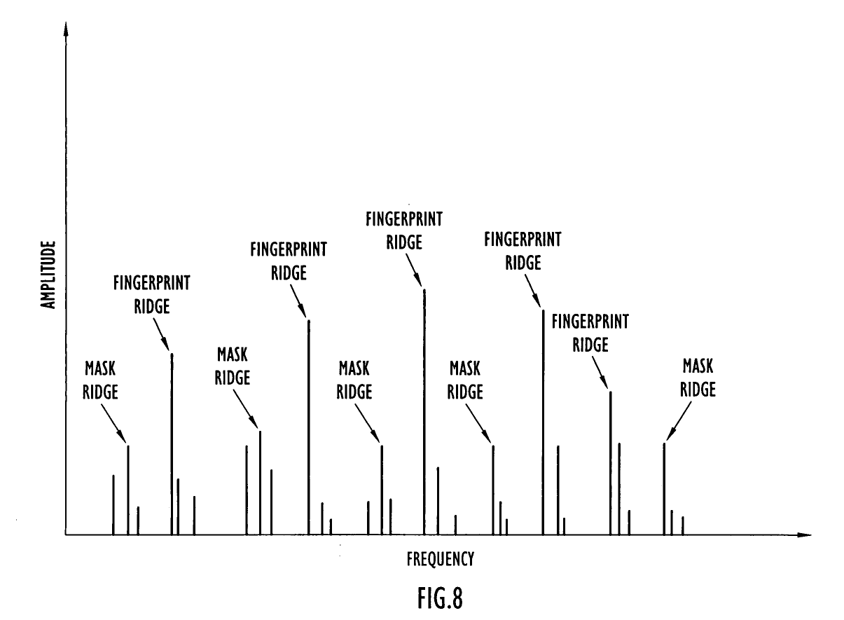

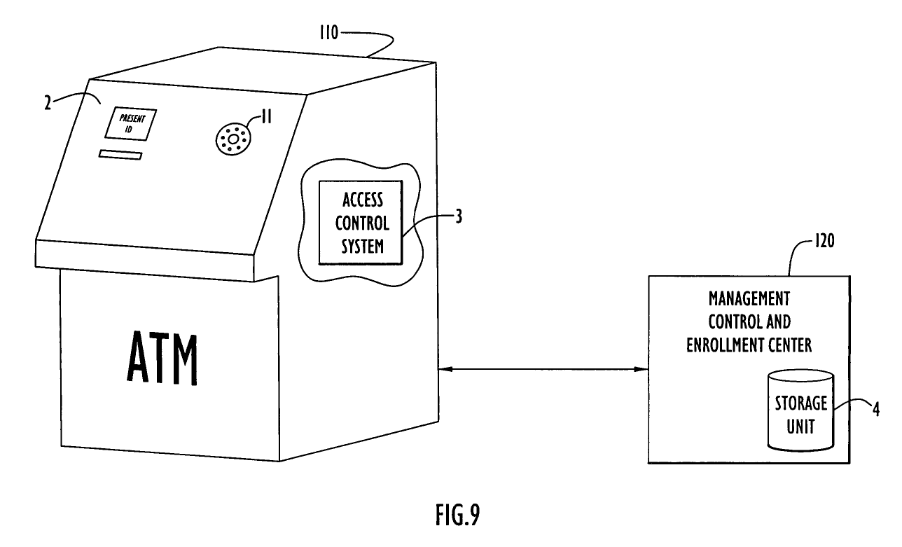

FIG. 8 shows an example of a spectral signal that may be output from the fingerprint sensor using the mask of FIG. 6. In this example, the mask ridges produce a regular pattern of peaks with lower amplitudes than the fingerprint ridges, which appear in a more sporadic or irregular pattern both in terms of amplitude and frequency. This pattern of peaks maybe compared to the stored identity patterns by the identification decision unit to return an identification result.

Another embodiment of the fingerprint sensor is also based on a SAW device, except in this embodiment the fingerprint is modified based on a pattern permanently or removably formed in the piezoelectric substrate itself. This pattern maybe, for example, a cross-hatch pattern which produces a predictable pattern of peaks in the spectral signal output from the sensor.

FIG. 9 shows an example of an electronic system which is protected by the access control system of the present invention. The system is in the form of an automatic teller machine 110 which includes an access point 2 and an access control processing system 3 as shown in FIG. 1. In operation, a person wishing to access funds or perform another financial transaction presents his distorted biometric to detector 11. A signal corresponding to the distorted print is transmitted to a management control and enrollment center 120 for comparison to the identity patterns in storage unit 4. A result of the comparison is transmitted back to the ATM machine and a relevant message is displayed. If access is granted, a door covering a slot for receiving a bank card (not shown) may move to a retracted position to allow the transaction to take place. The door will remain in its covered position if an access denied signal is received.

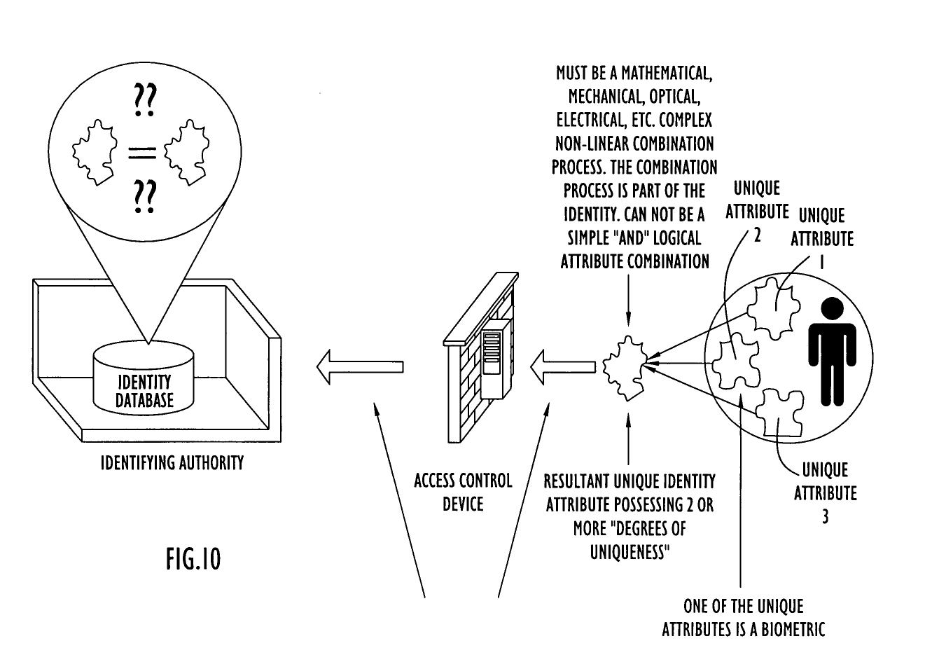

FIG. 10 is a conceptual drawing showing another embodiment of a system for identifying a person in accordance with the present invention. This system may include the same elements as shown in FIG. 1, e.g., access control device 130 may include or correspond to input unit 2 and an identifying authority 140 may include or correspond to identification decision unit 3 and database 4. However, unlike FIG. 1, instead of one distorted biometric multiple distorted biometrics are input into the system.

The multiple biometrics may include any of those previously discussed. For example, a first unique attribute may be a print distorted by a second unique attribute corresponding to the transfer function of the fingerprint sensor. A third unique attribute may be another biometric, a PIN, or another type of identification information. These attributes maybe input sequentially into the system and compared to enrolled information for returning a positive or negative identification result.

Another embodiment of the present invention includes a computer-readable medium storing a program which automatically performs the processing functions or steps of the methods previously described. This computer-readable medium may be a hard drive, a compact disk, a floppy disk, a memory chip, a flash memory, or any other type of medium capable of storing digital information. The processor that executes the program preferably performs the functions of decision unit 3 shown in FIG. 1. This processor may be incorporated into a desktop or portable computer (e.g., laptop, notebook, personal digital assistant (PDA), web-enabled phone, computer tablet), the control panel or input device of an access control system, or any other electronic system where identification, access control, or security is required.

Other modifications and variations to the invention will be apparent to those skilled in the art from the foregoing disclosure. Thus, while only certain embodiments of the invention have been specifically described herein, it will be apparent that numerous modifications maybe made thereto without departing from the spirit and scope of the invention.

1. A biometric sensing system, comprising:
a surface acoustic wave sensor; and
a modifier which causes the sensor to output a distorted print signal.

2. The system of claim 1, wherein the modifier is a transfer function of the sensor.

3. The system of claim 2, wherein the transfer function generates the print signal by distorting a print detected by the sensor in a predetermined manner.

4. The system of claim 1, wherein the modifier is a frequency of an excitation signal input into the sensor.

5. The system of claim 4, wherein the distorted print signal is generated by the sensor based on the excitation signal frequency.

6. The system of claim 1, wherein the modifier is a mask pattern coupled to the sensor.

7. The system of claim 6, wherein the print signal is indicative of a print which is distorted by the mask pattern in a predetermined manner.

8. The system of claim 6, wherein the mask pattern is included on a film placed over a print detecting surface of the sensor.

9. The system of claim 8, wherein the mask pattern includes one or more projections which deform a piezoelectric material in the sensor.

10. The system of claim 9, wherein the print signal represents a print which is distorted by the one or more projections in the mask pattern.

11. The system of claim 6, wherein the mask pattern is formed on a piezoelectric layer of the sensor.

12. The system of claim 11, wherein the mask pattern is permanently formed on the piezoelectric layer.

13. The system of claim 11, wherein the mask pattern is temporarily formed on the piezoelectric layer.

14. The system of claim 1, wherein the print is one of a fingerprint, thumb print, or palm print.

15. A sensor, comprising:
a detecting surface; and
a modifier which modifies a print detected by the detecting surface.

16. The sensor of claim 15, wherein the sensor is an surface acoustic wave sensor.

17. The sensor of claim 16, wherein the modifier is a predetermined transfer function of the sensor.

18. The sensor of claim 16, wherein the modifier is a frequency of an excitation signal input into the sensor.

19. The sensor of claim 15, wherein the modifier is a mask pattern.

20. The sensor of claim 19, wherein the mask pattern is formed on a piezoelectric layer of the sensor.

21. The sensor of claim 19, wherein the mask pattern is positioned between the detecting surface and the print.

22. The sensor of claim 15, wherein the print is one of a fingerprint, thumb print, and palm print.

23. A method for providing biometric information, comprising:
modifying a print; and
forming a distorted print signal from the modified print.

24. The method of claim 23, wherein modifying the print includes:
detecting the print with a surface acoustic wave sensor having a preselected transfer function.

25. The method of claim wherein modifying the print includes:
detecting the print with a surface acoustic wave sensor which operates based on a predetermined excitation frequency.

26. The method of claim 23, wherein modifying the print includes:
providing a mask pattern between the print and a detecting area of a surface acoustic wave sensor, said sensor outputting the distorted print signal based on a combination of the print and mask pattern.

27. The method of claim 23, wherein modifying the print includes:
forming a pattern on piezoelectric layer of a surface acoustic wave sensor, said sensor outputting the distorted print signal based on a combination of the print and pattern.

28. The method of claim 23, wherein the print is one of a fingerprint, thumb print, and palm print.

29. A method for generating biometric information, comprising:
combining two degrees two degrees of uniqueness, wherein the first degree of uniqueness is a print and second degree of uniqueness is a print modifier.
